(19) United States
(12) Patent Application Publication
(10) Pub. No.: US 2016/0338383 A1
(43) Pub. Date: Nov. 24, 2016

(54) WET PET FOOD FORMULATED TO BE SERVED IN A FORM SELECTED BY THE PET OWNER

(71) Applicant: NESTEC S.A., Vevey (CH)

(72) Inventor: Stephanie Daru, Aubigny (FR)

(21) Appl. No.: 15/158,024

(22) Filed: May 18, 2016

Related U.S. Application Data
(60) Provisional application No. 62/164,838, filed on May 21, 2015.

(51) Int. Cl. A23K 50/48; A23K 10/30; A23K 10/20

(52) U.S. Cl. CPC A23K 50/48; A23K 10/20; A23K 10/30

(57) ABSTRACT

A wet pet food is formulated to be served to a pet in a first form or in a second form, and the first and second forms of the wet pet food have the same ingredients and about the same amounts thereof relative to each other but different viscosities relative to each other. In a preferred embodiment, the first form is a ready-to-eat chunks in jelly, the second form is chunks in gravy, and heating the wet pet food changes the food from the first form into the second form. For example, the wet pet food can comprise meat chunks and further comprise a thermo-reversible hydrocolloid composition; the wet pet food can have a “chunks in jelly” form when served while having a temperature below 30° C. and can have a “chunks in gravy” form when served while having a temperature above 30° C., such as about 35° C.

### CROSS REFERENCE TO RELATED APPLICATIONS

This application claims priority to U.S. Provisional Application No. 62/164,838 filed May 21, 2015, the disclosure of which is incorporated herein by this reference.

### BACKGROUND

The present disclosure relates generally to pet food compositions formulated to be served to the pet in a form selected by the pet owner. More specifically, the present disclosure relates to wet pet foods that are packaged in a ready-to-eat form comprising a jelly and can be heated to obtain a form comprising a gravy.

Commercial food compositions may be classified into three main types based upon moisture and texture. First, “dry” food compositions contain less than about 12% moisture and water activity less than 0.65. They are typically hard, inelastic, and/or crumbly. Also, they are dry to the touch and stable under ambient conditions without the use of preservatives.

Second, “semi-moist” or “intermediate moisture” food compositions contain from about 12 to about 45% moisture and water activity of 0.65 to 0.9. They are softer than dry food compositions and are dry to the touch unless specially formulated to be moist to the touch. Generally, preservatives must be added to make them stable under ambient conditions. Intermediate moisture food compositions can be further classified as “soft-expanded” or “soft-moist.” Soft-expanded food compositions contain from about 12 to 25% moisture and water activity of 0.65 to 0.75. They are dry to the touch and soft and elastic. Soft-moist food compositions contain from about 25 to about 45% moisture and water activity of 0.75 to 0.9. They are non-sticky to the touch, very soft, viscous, and pliable.

Third, “wet” food compositions contain greater than about 45% moisture, typically from about 65 to about 82% and water activity greater than 0.9. They are usually soft and runny, particularly if they contain gravy. They are moist to the touch. Generally, they do not contain preservatives and are hermetically sealed and stabilized by heating, e.g., retorting. They tend to degrade and spoil within hours if exposed to ambient conditions, e.g., a container of wet food composition open to the atmosphere at room temperature.

The above ranges are generally applicable to most food compositions, particularly pet food compositions. However, the ranges can vary and overlap depending upon the particular food composition. Skilled artisans are able to identify the type of food based upon the composition and the conditions.

Of the three food categories, wet pet foods are perceived as the most palatable. Nevertheless, due to economies of scale, retail pet food manufacturers typically manufacture their pet foods in large quantities and a limited number of formulations. For example, most manufacturers offer dog food in several flavors and formulated in a puppy formula, an adult dog formula, and a mature or inactive dog formula. Some manufacturers offer breed-specific or size-specific formulas. Some manufacturers offer more specialized formulas for dogs having specific food allergies or nutrient responsive diseases. Similarly, retail cat food is typically offered in limited variety of formulas of different flavors or for different stages of development. However, the range of pet food choices does not meet the highly variable preferences of individual pets. For example, pet owners and pets have preferences regarding the form, flavor, shape and texture of the food; in particular, cats are extremely sensitive to small differences in food offered to them. Known pet foods are formulated to be served in one specific form and are not capable of being served in a different form that may be preferred by the pet.

### SUMMARY

The present disclosure relates to a wet pet food formulated to be served to a pet in a first form or in a second form, and the first and second forms of the wet pet food have the same ingredients and about the same amounts thereof relative to each other but different viscosities relative to each other. In a preferred embodiment, the first form is a ready-to-eat chunks in jelly, the second form is chunks in gravy, and heating the wet pet food changes the food from the first form into the second form. For example, the wet pet food can comprise meat chunks and further comprise a thermo-reversible hydrocolloid composition; the wet pet food can have a “chunks in jelly” form when served while having a temperature below 30° C. and can have a “chunks in gravy” form when served while having a temperature above 30° C., such as about 35° C.

Accordingly, in a general embodiment, a method of providing nutrition to a pet is provided. The method comprises: heating a wet pet food comprising chunks and further comprising a thermo-reversible hydrocolloid composition; and administering the heated wet pet food to the pet.

In an embodiment, the wet pet food is a ready-to-eat food formulated to be administered to the pet without heating.

In an embodiment, the thermo-reversible hydrocolloid composition comprises gelatin.

In an embodiment, the heated wet pet food is administered to the pet while the heated wet pet food has a temperature greater than 30° C.

In an embodiment, the wet pet food is packaged in a pouch, and the heating comprises positioning the pouch at least partially in water having a temperature greater than ambient temperature.

In an embodiment, the pet is a cat.

In another embodiment, a method of providing nutrition to a pet is provided. The method comprises: administering a first wet pet food having a first temperature to a pet; and administering a second wet pet food having a second temperature to the pet, the first and second wet pet foods consist of identical ingredients and approximately identical amounts of the ingredients relative to each other and are administered at different times relative to each other, the first and second temperatures are different than each other, and the ingredients comprise a thermo-reversible hydrocolloid composition.

In an embodiment, the first wet pet food is administered while having a temperature not greater than ambient temperature (25° C.), and the second wet pet food is administered while having a temperature of at least 30° C.

In an embodiment, the second wet pet food has a different viscosity relative to the first wet pet food.

In an embodiment, the first wet pet food has a form of chunks in jelly, and the second wet pet food has a form of chunks in gravy.

In another embodiment, a ready-to-eat wet pet food is provided. The food comprises chunks, further comprises a thermo-reversible hydrocolloid composition, and is formulated to be a chunks in jelly pet food when having a temperature of less than 30° C. and a chunks in gravy pet food when having a temperature greater than 30° C.

In an embodiment, the ready-to-eat wet pet food has a ratio of the chunks to the thermo-reversible hydrocolloid composition of 30:70 to 70:30.

In an embodiment, the chunks comprise an ingredient selected from the group consisting of a meat, a meat by-product, a cereal, a vegetable protein, and combinations thereof.

In an embodiment, the thermo-reversible hydrocolloid composition comprises gelatin. The gelatin can be about 10 wt % of the thermo-reversible hydrocolloid composition.

In an embodiment, the food is formulated to provide complete and balanced nutrition to a companion animal.

In another embodiment, a method of preparing a food product is provided. The method comprises: preparing chunks; preparing a thermo-reversible hydrocolloid composition; and mixing the chunks with the thermo-reversible hydrocolloid composition to produce a ready-to-eat wet pet food formulated to be a chunks in jelly pet food when having a temperature of less than 30° C. and a chunks in gravy pet food when having a temperature greater than 30° C.

In an embodiment, the method comprises filling the ready-to-eat wet pet food into a container, sealing the container with the ready-to-eat wet pet food therein, and retorting the sealed container.

In an embodiment, the mixing comprises adding the chunks, while the chunks are at a temperature above ambient temperature, to a container containing the thermo-reversible hydrocolloid composition, while the thermo-reversible hydrocolloid composition is in fluid form.

In an embodiment, a product is provided. The product comprises: a container; and a ready-to-eat wet pet food sealed in the container, comprising chunks, further comprising a thermo-reversible hydrocolloid composition, and formulated to be a chunks in jelly pet food when having a temperature of less than 30° C. and a chunks in gravy pet food when having a temperature greater than 30° C., the container configured to be subjected to heat treatment that increases the temperature of the ready-to-eat wet pet food to greater than 30° C.

An advantage of the present disclosure is to provide the opportunity for the cat owner to serve a wet food product to their animal in at least two different ways while buying a single product.

Another advantage of the present disclosure is to provide a wet food that can easily be made into chunks in gravy form, for example by heating.

Yet another advantage of the present disclosure is to provide a wet food that has a ready-to-eat chunks in jelly form if the pet owner or the pet prefers this form and/or prefers to not heat the wet food.

Still another advantage of the present disclosure is to provide a wet pet food that is a chunks in jelly product at ambient temperature, and the wet food becomes a chunks in gravy product after a warm-up step.

Another advantage of the present disclosure is to enable a pet owner to serve the same product to a pet in either cold or warm form.

Yet another advantage of the present disclosure is to enable a pet owner to provide some meal variety to their pet by enabling the pet owner to change at least two parameters of a meal, namely temperature and texture, merely by heating the meal.

Additional features and advantages are described herein and will be apparent from the following Detailed Description and the Figures.

### BRIEF DESCRIPTION OF THE FIGURES

FIG. 1 contains photographs from a kitchen trial which used an embodiment of the wet pet food according to the present disclosure.

### DETAILED DESCRIPTION

As used in this disclosure and the appended claims, the singular forms “a,” “an” and “the” include plural referents unless the context clearly dictates otherwise. Thus, for example, reference to “a hydrocolloid” or “the hydrocolloid” includes two or more hydrocolloids. The term “and/or” used in the context of “X and/or Y” should be interpreted as “X,” or “Y,” or “X and Y.” Where used herein, the term “example,” particularly when followed by a listing of terms, is merely exemplary and illustrative, and should not be deemed to be exclusive or comprehensive.

As used herein, “about” and “approximately” are understood to refer to numbers in a range of numerals, for example the range of −10% to +10% of the referenced number, preferably within −5% to +5% of the referenced number, more preferably within −1% to +1% of the referenced number, most preferably within −0.1% to +0.1% of the referenced number. Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

All percentages expressed herein are by weight of the total weight of the food composition unless expressed otherwise. When reference is made to the pH, values correspond to pH measured at ambient temperature with standard equipment. “Ambient temperature” is about 20° C.

The terms “food,” “food product” and “food composition” mean a product or composition that is intended for ingestion by an animal, including a human, and provides at least one nutrient to the animal. A “ready-to-eat” food composition is formulated to be served without the addition of further ingredients to the composition and without adjusting the temperature of the composition to a higher value than its temperature at ambient conditions.

The term “pet food” means any food composition intended to be consumed by a pet. The term “pet” means any animal which could benefit from or enjoy the compositions provided by the present disclosure. For example, the pet can be an avian, bovine, canine, equine, feline, hircine, lupine, murine, ovine, or porcine animal, but the pet can be any suitable animal. The term “companion animal” means a dog or a cat.

The characterization of food compositions herein is consistent with the disclosure of the background above. Specifically, a “dry” food composition has less than about 12% moisture and a water activity less than 0.65. A “semi-moist” food composition has about 12% to about 45% moisture and a water activity of 0.65 to 0.9 and includes “soft-expanded” food compositions containing from about 12% to 25% moisture and water activity of 0.65 to 0.75 and “soft-moist” food compositions containing from about 25% to about 45% moisture and water activity of 0.75 to 0.9. A “wet” food composition contains greater than about 45% moisture, typically from about 65% to about 82%, and water activity greater than 0.9.

The term “hydrocolloid” means any food grade compound that transitions between a gel state and a sol state based on temperature. A “thermo-reversible hydrocolloid” is any hydrocolloid that is formed by cooling a warm solution and then can be returned to the sol state by heating again, contrary to “thermo-irreversible” hydrocolloids that cannot be returned to the sol state after gelation. Non-limiting examples of suitable thermo-reversible hydrocolloids include gelatin, agar, kappa carrageenan, iota carrageenan, low methoxy pectin, gellan gum, hydroxypropyl methyl cellulose, xanthan gum, locust bean gum, konjac mannan, or combinations thereof. A “thermo-reversible hydrocolloid composition” is any composition comprising a thermo-reversible hydrocolloid, for example a jelly or a gravy.

As used herein, “gelatin” is the product obtained from the acid, alkaline, or enzymatic hydrolysis of collagen. Non-limiting examples of suitable sources of collagen are skin, bones, and connective tissue of animals, including fish and poultry. As used herein, “gelatin” includes gelatin derived from acid-treated collagen (Type A gelatin) and gelatin derived from alkali-treated collagen (Type B gelatin).

The compositions disclosed herein may lack any element that is not specifically disclosed herein. Thus, a disclosure of an embodiment using the term “comprising” includes a disclosure of embodiments “consisting essentially of” and “consisting of” the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified. Any embodiment disclosed herein can be combined with any other embodiment disclosed herein unless explicitly and directly stated otherwise.

In an aspect of the present disclosure, a wet pet food is formulated to be served to a pet in a first form or in a second form, and the first and second forms have the same ingredients relative to each other but different viscosities. In a preferred embodiment, the first form is a ready-to-eat chunks in jelly, the second form is chunks in gravy, and heating the wet pet food changes the food from the first form into the second form. Preferably both the first and second forms are ready-to-eat foods that do not require additional ingredients or additional processing.

In an embodiment, the wet pet food is chunks in jelly at a temperature of less than 30° C., such as ambient temperatures, and is heated to a temperature greater than 30° C., such as 30 to 40° C., to obtain the form of chunks in gravy. Preferably, the wet pet food is packaged in a suitable container, for example a can, a pouch, a glass container, or a plastic container. In an embodiment in which the wet pet food is packaged in a pouch, the food can be heated by positioning at least part of the pouch in a container of heated water or holding at least part of the pouch under heated water that is flowing from a faucet or tap. As a non-limiting example of heating that is sufficient for some embodiments of the wet pet food to change forms, water having a temperature of about 80° C. can be applied for about five minutes to a pouch containing the food.

Without being bound by theory, the present inventors believe that a heated temperature of the wet pet food increases palatability of the food for the pet, particularly for a cat; cats are obligate carnivores and may prefer food having a temperature similar to that of prey.

In an embodiment, the wet pet food comprises chunks and further comprises a composition comprising a thermo-reversible hydrocolloid (hereafter “the thermo-reversible hydrocolloid composition”). The thermo-reversible hydrocolloid composition can be in a gel state when the food is in the first form (e.g., chunks in jelly) and can be in a sol state when the food is in the second form (e.g. chunks in gravy, after heating). The ratio of the chunks to the thermo-reversible hydrocolloid composition can be 30:70 to 70:30, for example about 40:60, about 45:55 or about 50:50.

In a preferred embodiment, the thermo-reversible hydrocolloid is gelatin. The thermo-reversible hydrocolloid can be 7% to 13% of the thermo-reversible hydrocolloid composition, preferably 8% to 12%, more preferably 9% to 11%, and most preferably about 10%.

In an embodiment, the chunks can be approximately evenly distributed throughout the wet pet food in both the first and second forms, and the thermo-reversible hydrocolloid composition (e.g., jelly or gravy) can be approximately evenly distributed throughout the wet pet food in both the first and second forms. For example, the wet pet food can be substantially uniform such that similarly sized sections of the food have substantially the same amount of the chunks by weight relative to each other and/or substantially the same amount of the thermo-reversible hydrocolloid composition by weight relative to each other.

The chunks preferably have at least about 50% moisture and can contain meat, meat by-products, cereals, vegetable proteins, and the like, and the wet pet food is not limited to a specific embodiment of the chunks. Non-limiting examples of suitable chunks are disclosed in U.S. Pat. Nos. 4,781,939; 5,433,968; 5,567,466; 6,379,738; 6,649,206; 7,604,829; and 7,736,686, all assigned to the Applicant of the present application and incorporated by reference in their entireties. Other non-limiting examples of suitable chunks include chunks of real meat, such as beef, pork, chicken, turkey, lamb, fish or combinations thereof. Yet another non-limiting example of suitable chunks is meatballs made from such meats.

In some embodiments, the chunks having at least about 50% moisture can be supplemented with dry or semi-moist chunks, for example particulates; pellets; pieces of pet food, dehydrated meat, meat analog, vegetables, and combinations thereof; and pet snacks, such as meat or vegetable jerky, rawhide, and biscuits. These supplemental chunks are preferably used in much smaller quantities than the chunks having at least about 50% moisture, for example as condiments and/or visual appeal. In an embodiment, the chunks having at least about 50% moisture are the only chunks in the wet pet food.

The thermo-reversible hydrocolloid composition comprises water and optionally comprises one or more of colorants, flavorants, condiments, or salts. In an embodiment, the thermo-reversible hydrocolloid composition comprises another gum, non-limiting examples of which include guar gum, tara gum, cassia gum or combinations thereof.

Non-limiting examples of suitable colorants include FD&C colors, such as blue no. 1, blue no. 2, green no. 3, red no. 3, red no. 40, yellow no. 5, yellow no. 6, and the like; natural colors, such as roasted malt flour, caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan. Non-limiting examples of suitable flavorants include yeast, tallow, rendered animal meals (e.g., poultry, beef, lamb, and pork), flavor extracts or blends (e.g., grilled beef), animal digests, and the like. Non-limiting examples of suitable condiments include parsley, oregano, and the like.

The chunks can vary in size depending upon the animal that will consume the product, e.g., the type, age, health, or size of the animal. For example, chunk sizes suitable for dogs typically range from about 10 to 80 millimeters (mm), preferably 20 to 40 mm, on the longest side. Chunk sizes for cats typically range from 3 to 30 mm, preferably 8 to 20 mm, on the longest side.

In various embodiments, the wet pet food comprises additional ingredients such as vitamins, minerals, amino acids, nucleic acids, fillers, palatability enhancers, binding agents, flavors, stabilizers, emulsifiers, sweeteners, colorants, buffers, salts, coatings, condiments, preservatives, and the like.

Non-limiting examples of supplementary minerals include calcium, phosphorous, potassium, sodium, iron, chloride, boron, copper, zinc, magnesium, manganese, iodine, selenium, and the like. Non-limiting examples of supplementary vitamins include vitamin A, any of the B vitamins, vitamin C, vitamin D, vitamin E, and vitamin K, including various salts, esters, or other derivatives of the foregoing. Additional dietary supplements may also be included, for example, any form of niacin, pantothenic acid, inulin, folic acid, biotin, amino acids, and the like, as well as salts and derivatives thereof.

Stabilizers include substances that tend to increase the shelf life of the wet pet food, such as preservatives, synergists and sequestrants, packaging gases, emulsifiers, thickeners, gelling agents, and humectants. Examples of emulsifiers and/or thickening agents include cellulose ethers, starch, starch esters, starch ethers, and modified starches.

Selection of the ingredients and their amounts is known to skilled artisans. Specific amounts for each additional ingredient will depend on a variety of factors such as the ingredient included in the wet pet food; the species of animal; the animal's age, body weight, general health, sex, and diet; the animal's consumption rate; the purpose for which the wet pet food is administered to the animal; and the like. Therefore, the component and ingredient amounts may vary widely and may deviate from the preferred proportions described herein.

In an embodiment, the wet pet food is formulated to provide “complete and balanced” nutrition for an animal, preferably a companion animal, according to standards established by the Association of American Feed Control Officials (AAFCO).

The wet pet food can be prepared by any method known to the skilled artisan for preparing chunks in jelly pet food and/or chunks in gravy pet food. For example, the method can comprise a) preparing chunks; b) preparing a thermo-reversible hydrocolloid composition (e.g., a jelly); and c) mixing the chunks with the thermo-reversible hydrocolloid composition to produce the wet pet food. Optionally, the method further comprises one or more steps of (1) filling the wet pet food into a container, (2) sealing the container, and (3) retorting the container. In a preferred embodiment the chunks, while hot, are added to a container containing the thermo-reversible hydrocolloid composition in fluid form and mixed with the fluid thermo-reversible hydrocolloid composition. The mixture is then transferred to a container, sealed, and retorted to produce a chunks in jelly pet food.

In another aspect of the present disclosure, a method of providing nutrition to a pet is provided. The pet can be a companion animal, preferably a cat. The method comprises administering any of the embodiments of the wet pet food disclosed herein. For example, the method can comprise heating any of the embodiments of the wet pet food disclosed herein and then administering the heated wet pet food to the pet. In an embodiment, the heated wet pet food has a temperature of at least 30° C., such as 30 to 40° C.

The method can comprise administering a first wet pet food having a first temperature to a pet and administering a second wet pet food having a second temperature to the pet, the first and second wet pet foods consist of identical ingredients relative to each other and are administered at different times relative to each other, and the first and second temperatures are different than each other. The ingredients comprise a thermo-reversible hydrocolloid composition. In an embodiment, the first wet pet food is administered while having a temperature not greater than ambient temperature, and the second wet pet food is administered while having a temperature of at least 30° C., such as 30 to 40° C.

### Example

The following non-limiting example is illustrative of an embodiment of a wet pet food provided by the present disclosure.

A thermo-reversible hydrocolloid composition was prepared according to Table 1 below. The flavor component consisted of D-Xylose (0.20%), Glycine powder (1.50%), and Choline Chloride (0.09%).

TABLE 1

| Ingredient | % |
|---|---|
| Gelatin (250 Bloom) | 10.0 |
| Flavor | 1.79 |
| Color (burnt sugar syrup) | 0.15 |
| Guar Gum | 0.60 |
| Xanthan Gum | 0.06 |
| Water | 87.4 |
| Total | 100 |

Water was measured into a steam-jacketed stainless steel tank and warmed to 70° C. The gelatin powder was then dissolved in the warm water with continuous stirring with a high speed mixer. The other dry components (flavor, color, and gums) were then added while stirring for additional two minutes to form the gravy. The gravy was kept recirculating slowly (a rate below which foaming does not occur) until use.

The resultant gravy was then mixed with chunks at a 50:50 ratio, although the ratio can be adapted depending on the nutrition and industrialization constraints. The mixing was achieved by manually dosing the chunks into pre-formed pouches. The gravy was added on the top of the chunks in the pouches. Finally, the pouches were sealed manually then retorted.

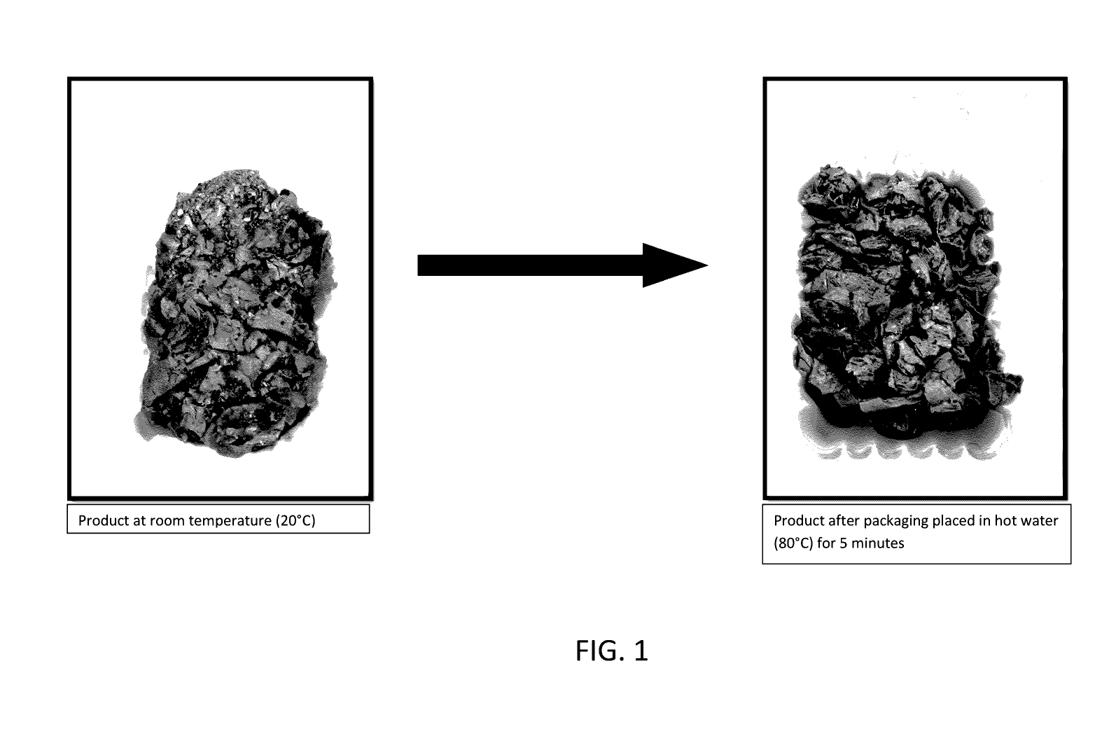

FIG. 1 shows the product at room temperature (left panel). The packaging (pouch in this example, but a can is contemplated as well) was placed in in hot water in order to transform the chunk in jelly in chunk in gravy. The pouch was placed in a “bain marie” (water bath at 80° C.) for 5 minutes (right panel). The product can then be emptied from the pouch to a feeding dish.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of providing nutrition to a pet comprising:
heating a wet pet food comprising chunks and further comprising a thermo-reversible hydrocolloid composition; and
administering the heated wet pet food to the pet.

2. The method of claim 1, wherein the wet pet food is a ready-to-eat food formulated to be administered to the pet without heating.

3. The method of claim 1, wherein the thermo-reversible hydrocolloid composition comprises gelatin.

4. The method of claim 1, wherein the heated wet pet food is administered to the pet while the heated wet pet food has a temperature greater than 30° C.

5. The method of claim 1, wherein the wet pet food is packaged in a pouch, and the heating comprises positioning the pouch at least partially in water having a temperature greater than ambient temperature.

6. The method of claim 1, wherein the pet is a cat.

7. A method of providing nutrition to a pet comprising:
administering a first wet pet food having a first temperature to a pet; and
administering a second wet pet food having a second temperature to the pet,
the first and second wet pet foods consist of identical ingredients and approximately identical amounts of the ingredients relative to each other and are administered at different times relative to each other, the first and second temperatures are different than each other, and the ingredients comprise a thermo-reversible hydrocolloid composition.

8. The method of claim 7, wherein the first wet pet food is administered while having a temperature not greater than ambient temperature, and the second wet pet food is administered while having a temperature of at least 30° C.

9. The method of claim 7, wherein the second wet pet food has a different viscosity relative to the first wet pet food.

10. The method of claim 7, wherein the first wet pet food has a form of chunks in jelly, and the second wet pet food has a form of chunks in gravy.

11. A ready-to-eat wet pet food comprising chunks, further comprising a thermo-reversible hydrocolloid composition, and formulated to be a chunks in jelly pet food when having a temperature of less than 30° C. and a chunks in gravy pet food when having a temperature greater than 30° C.

12. The ready-to-eat wet pet food of claim 11, having a ratio of the chunks to the thermo-reversible hydrocolloid composition of 30:70 to 70:30.

13. The ready-to-eat wet pet food of claim 11, wherein the chunks comprise an ingredient selected from the group consisting of a meat, a meat by-product, a cereal, a vegetable protein, and combinations thereof.

14. The ready-to-eat wet pet food of claim 11, wherein the thermo-reversible hydrocolloid composition comprises gelatin.

15. The ready-to-eat wet pet food of claim 14, wherein the gelatin is about 10 wt % of the thermo-reversible hydrocolloid composition.

16. The ready-to-eat wet pet food of claim 11, wherein the food is formulated to provide complete and balanced nutrition to a companion animal.

17. A method of preparing a food product comprising:
preparing chunks;
preparing a thermo-reversible hydrocolloid composition; and
mixing the chunks with the thermo-reversible hydrocolloid composition to produce a ready-to-eat wet pet food formulated to be a chunks in jelly pet food when having a temperature of less than 30° C. and a chunks in gravy pet food when having a temperature greater than 30° C.

18. The method of claim 17, comprising filling the ready-to-eat wet pet food into a container, sealing the container with the ready-to-eat wet pet food therein, and retorting the sealed container.

19. The method of claim 17, wherein the mixing comprises adding the chunks, while the chunks are at a temperature above ambient temperature, to a container containing the thermo-reversible hydrocolloid composition, while the thermo-reversible hydrocolloid composition is in fluid form.

20. A product comprising:
a container; and
a ready-to-eat wet pet food sealed in the container, comprising chunks, further comprising a thermo-reversible hydrocolloid composition, and formulated to be a chunks in jelly pet food when having a temperature of less than 30° C. and a chunks in gravy pet food when having a temperature greater than 30° C.,
the container configured to be subjected to heat treatment that increases the temperature of the ready-to-eat wet pet food to greater than 30° C.
